(19) United States
(12) Patent Application Publication
(10) Pub. No.: US 2025/0211632 A1
(43) Pub. Date: Jun. 26, 2025

(54) DATA TRANSMISSION SYSTEM, DATA TRANSMISSION METHOD, AND RECORDING MEDIUM

(71) Applicant: Panasonic Automotive Systems Co., Ltd., Kanagawa (JP)

(72) Inventors: Yota KAMBAYASHI, Osaka (JP); Naoki IKEMOTO, Osaka (JP)

(73) Assignee: Panasonic Automotive Systems Co., Ltd., Kanagawa (JP)

(21) Appl. No.: 18/972,354

(22) Filed: Dec. 6, 2024

(30) Foreign Application Priority Data
Dec. 25, 2023 (JP) 2023-218660

(51) Int. Cl. H04L 67/1008; H04L 67/04; H04L 67/12

(52) U.S. Cl. CPC H04L 67/1008; H04L 67/04; H04L 67/12

(57) ABSTRACT

A data transmission system includes: a receiver that receives, from a first vehicle, (i) a distribution request to distribute an application and (ii) first performance information indicating performance of an in-vehicle device provided to the first vehicle; a determiner that determines whether the application is operable in the first vehicle, based on the first performance information and a model corresponding to the application, the model being built based on operation data of each of one or more second vehicles to which the application has been distributed; and a transmitter that distributes the application to the first vehicle when the determiner determines that the application is operable in the first vehicle.

### CROSS REFERENCE TO RELATED APPLICATION

The present application is based on and claims priority of Japanese Patent Application No. 2023-218660 filed on Dec. 25, 2023.

### FIELD

The present disclosure relates to a data transmission system, a data transmission method, and a recording medium.

### BACKGROUND

PTL 1 discloses a data transmission system capable of transmitting, to a terminal device, software that matches version information on the platform of the terminal device.

### CITATION LIST

### Patent Literature

PTL 1: Japanese Unexamined Patent Application Publication No. 2001-5671

### SUMMARY

However, the data transmission system according to Patent Literature (PTL) 1 can be improved upon.

In view of this, the present disclosure provides a data transmission system, a data transmission method, and a recording medium capable of improving upon the above related art.

A data transmission system according to an aspect of the present disclosure includes: a receiver that receives, from a first vehicle, (i) a distribution request to distribute an application and (ii) first performance information indicating performance of an in-vehicle device provided to the first vehicle; a determiner that determines whether the application is operable in the first vehicle, based on the first performance information and a model corresponding to the application, the model being built based on operation data of each of one or more second vehicles to which the application has been distributed; and a transmitter that distributes the application to the first vehicle when the determiner determines that the application is operable in the first vehicle.

A data transmission method according to an another aspect of the present disclosure includes: receiving, from a first vehicle, a distribution request for an application and first performance information indicating performance of an in-vehicle device provided to the first vehicle; determining whether the application is operable in the first vehicle, based on the first performance information and a model corresponding to the application, the model being built based on operation data of each of one or more second vehicles to which the application has been distributed; and distributing the application to the first vehicle when the determining is made that the application is operable in the first vehicle.

A recording medium according to a still another aspect of the present disclosure is a non-transitory computer-readable recording medium for use in a computer, the recording medium having recorded thereon a computer program for causing the computer to execute the above-described data transmission method.

The data transmission system and the like according to the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the configuration of a data transmission system according to an embodiment.

FIG. 2A is a diagram for describing an example of hardware performance information included in operation data, according to the embodiment.

FIG. 2B is a diagram for describing an example of operation logs included in the operation data, according to the embodiment.

FIG. 3 is a diagram illustrating an example of hardware performance information on a vehicle that has requested to distribute an application, according to the embodiment.

FIG. 4 is a flowchart illustrating operations of the data transmission system according to the embodiment.

FIG. 5 is a diagram illustrating an example of acceptable load information for the vehicle that has requested to distribute the application, according to the embodiment.

FIG. 6 is a diagram illustrating an example of the result of predicting loads under the assumption that the application is operated in the vehicle that has requested to distribute the application, and an operability determination result, according to the embodiment.

FIG. 7 is a diagram illustrating an example of the result of predicting loads under the assumption that a lightweight version of the application is operated in the vehicle that has requested to distribute the application, and an operability determination result, according to the embodiment.

FIG. 8 is a diagram illustrating an example of a screen for recommending the lightweight version of the application, according to this embodiment.

FIG. 9 is a schematic diagram for describing the determination of the operability of the application based on the version of the platform of an in-vehicle device, according to the embodiment.

### DESCRIPTION OF EMBODIMENTS

### (Circumstances Leading to the Present Disclosure)

In a typical conventional in-vehicle device, fixed applications (apps) are used, and the operation of the applications depends only on the performance of the in-vehicle device or on the version of the platform of the in-vehicle device. However, future use cases are expected such that a user downloads any application to an in-vehicle device, as in devices such as smartphones. In such use cases, in-vehicle devices at the same performance level or with the same platform version may vary in resource use state due to differences in applications running in the in-vehicle devices, leading to variations in the operation of the applications. For example, for two in-vehicle devices at the same performance level, an application may operate smoothly in one device but not in the other. It is therefore desirable to restrict downloadable applications for each in-vehicle device. For example, each in-vehicle device is desirably allowed to download only applications operable smoothly in that in-vehicle device.

An in-vehicle device may include the following components: functional components that perform processing, implemented by units such as a central processing unit (CPU), a graphics processing unit (GPU), and a micro processor unit (MPU); and a memory unit, such as read only memory (ROM) and random access memory (RAM), that stores programs for causing the functional components to perform various sorts of processing. An in-vehicle device is a computer provided in a vehicle. An in-vehicle device is implemented by, for example, an electronic control unit (ECU).

As mentioned above in Background, the technique in PTL 1 takes into account only the version of the platform of an in-vehicle device but not the performance of the in-vehicle device. This may result in a case in which, although an application (app) that matches the version of the platform is downloaded, the application cannot be used smoothly (e.g., the application does not operate smoothly) because the specs of the in-vehicle device fail to meet requirements. That is, PTL 1 does not disclose a technique that allows downloading an application operable smoothly in an in-vehicle device.

Through a careful study on data transmission systems and other aspects that allow downloading an application expected to operate smoothly in an in-vehicle device, the inventors of the present application have devised a data transmission system and other aspects to be described below. Specifically, the inventors have devised a data transmission system and other aspects in which whether an application is operable in an in-vehicle device can be determined based on the performance of the in-vehicle device, and on a prediction model that predicts processing loads under the assumption that the application is operated in the in-vehicle device.

Hereinafter, a certain exemplary embodiment will be described in detail with reference to the accompanying Drawings.

The following embodiment is a general or specific example of the present disclosure. The numerical values, shapes, materials, elements, arrangement and connection configuration of the elements, steps, the order of the steps, etc., described in the following embodiment are merely examples, and are not intended to limit the present disclosure. Among elements in the following embodiment, those not described in any one of the independent claims indicating the broadest concept of the present disclosure are described as optional elements.

It should be noted that components that are essentially the same share like reference signs in the figures. Accordingly, overlapping explanations thereof are omitted or simplified.

It should also be noted that the following description may include numerical values and numerical value ranges. However, such numerical values and numerical value ranges do not mean exact meanings only. They also mean the substantially same ranges including a difference of, for example, about several % (or about 10%) from the completely same range.

In the following description, the ordinal numerals, such as “first” and “second”, do not mean numbers or an order of the constituent elements, unless otherwise specified. They are used to distinguish the constituent elements of the same type from each other, preventing the constituent elements from being mixed up.

### Embodiment

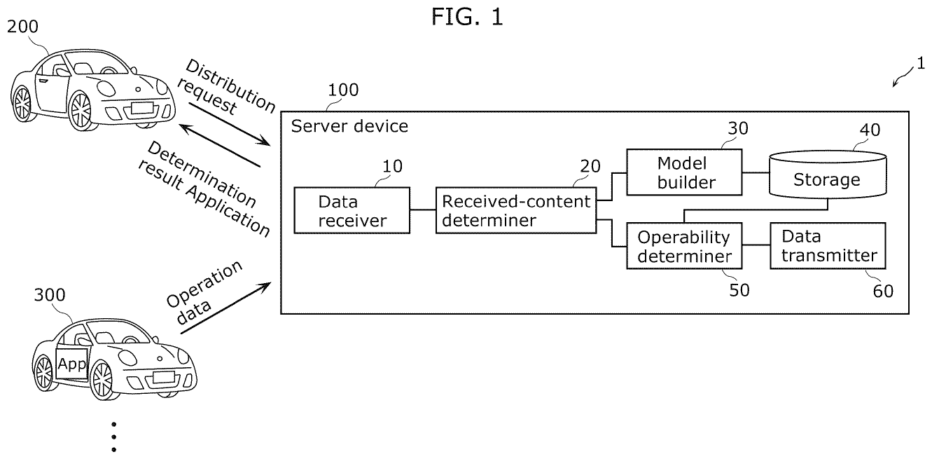

A data transmission system and other aspects according to an embodiment will be described below with reference to FIGS. 1 to 9.

### [1. Configuration of Data Transmission System]

With reference to FIGS. 1 to 3, the configuration of the data transmission system according to this embodiment will be described. FIG. 1 is a block diagram illustrating the configuration of data transmission system 1 according to this embodiment.

As illustrated in FIG. 1, data transmission system 1 includes server device 100 and vehicles 200 and 300. It is to be noted that data transmission system 1 may include at least server device 100.

Vehicle 200 is a vehicle to which a target application has not been downloaded. Vehicle 200 issues, to server device 100, a distribution request to distribute the target application. At the point when vehicle 200 issues the distribution request to distribute the target application, it is unknown whether the target application will operate smoothly in an in-vehicle device in vehicle 200. Vehicle 200 is an example of a first vehicle.

Vehicles 300 are vehicles to which the target application has been downloaded. Each vehicle 300 transmits, to server device 100, operation data that includes data on processing loads imposed while the target application is operating.

Vehicles 300 were determined in the past by server device 100 to be eligible to receive the application. It is to be noted that data transmission system 1 may include any number of vehicles 300 greater than or equal to one. Vehicles 300 are examples of second vehicles.

Server device 100 manages the distribution of applications that operate in vehicles. In this embodiment, server device 100 performs various sorts of processing for distributing an application to vehicle 200 in response to receiving, from vehicle 200, a distribution request to distribute the application. Server device 100 is characterized in that it determines whether the application can be distributed to vehicle 200 based on processing loads predicted under the assumption that the application is operated in vehicle 200.

Server device 100 is implemented by a computer that includes the following exemplary components: a communication interface for communicating with entities such as vehicles 200 and 300; a nonvolatile memory that stores programs executed by processing units; a volatile memory serving as a temporary memory area for executing programs; an input/output port for signal transmission and reception; and processors that execute programs. The communication interface is implemented by a wireless communication circuit for performing wireless communication, although it may be implemented by, for example, a connector to which a communication line is connected for performing wired communication. Server device 100 may be a cloud server or a local server.

Server device 100 includes data receiver 10, received-content determiner 20, model builder 30, storage 40, operability determiner 50, and data transmitter 60.

Data receiver 10, which includes a communication interface for communicating with vehicles 200 and 300, receives predetermined data. For example, data receiver 10 receives, from vehicle 200, a distribution request to distribute an application. Data receiver 10 also receives operation data from vehicles 300. Data receiver 10 includes, for example, a wireless communication circuit (a wireless communication module). Data receiver 10 is an example of a receiver.

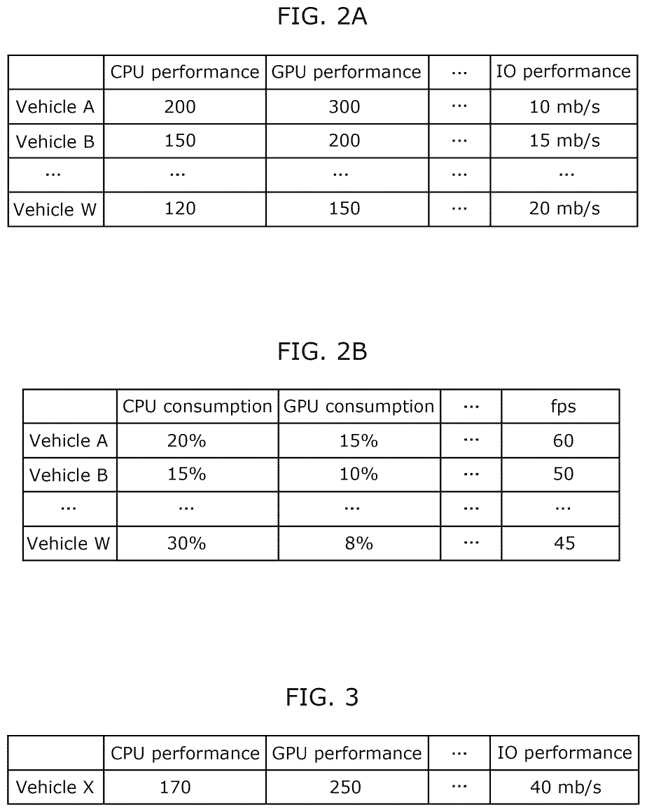

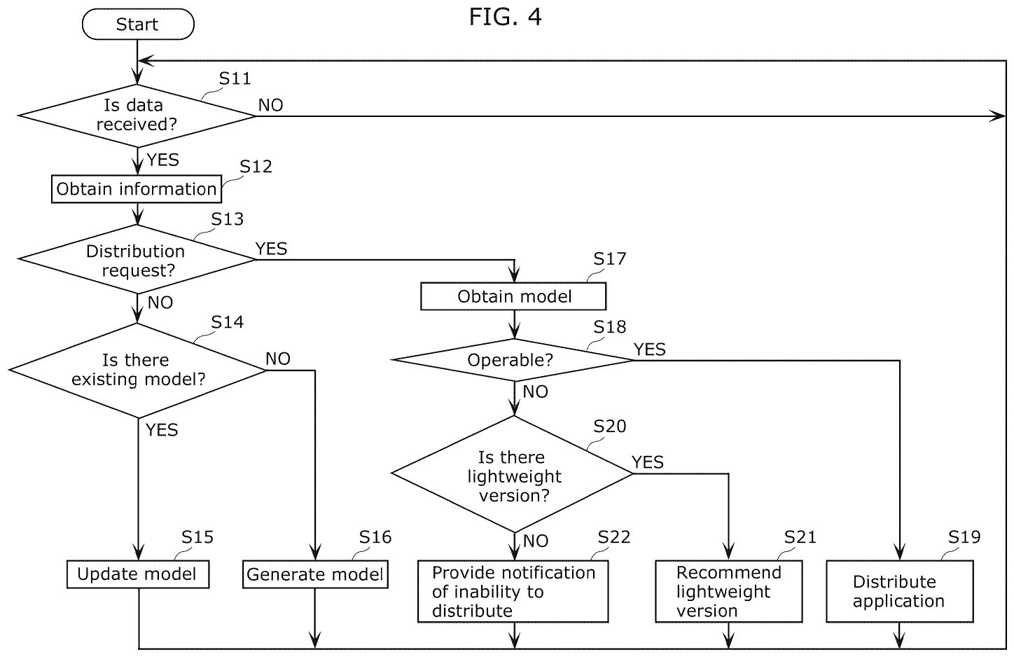

Here, with reference to FIGS. 2A to 3, information items received by data receiver 10 will be described. The operation data includes performance information indicating the performance of an in-vehicle device in each vehicle 300, and an operation log regarding the operation of the requested application in the in-vehicle device in each vehicle 300. FIG. 2A illustrates the performance information, and FIG. 2B illustrates the operation logs.

FIG. 2A is a diagram for describing an example of hardware performance information included in the operation data, according to this embodiment. FIG. 2A shows a list of hardware performance information received from vehicles 300 (vehicles A to W). FIG. 2B is a diagram for describing an example of operation logs included in the operation data, according to this embodiment. FIG. 2B shows a list of operation logs received from vehicles 300 (vehicles A to W). FIG. 3 is a diagram illustrating an example of hardware performance information on vehicle 200 (vehicle X in the example in FIG. 3) that has requested to distribute the application, according to this embodiment.

As illustrated in FIG. 2A, the hardware performance information includes information indicating the performance of each piece of hardware (processing unit) in each vehicle 300. In the example in FIG. 2A, this information includes the performance of a CPU, a GPU, and an input/output (IO) controller (CPU performance, GPU performance, and IO performance). The hardware performance information may also include the performance of other pieces of hardware, such as a RAM, related to the operation of applications. It is to be noted that the hardware performance information may include the performance of at least one of the pieces of hardware related to the operation of applications.

The performance of a piece of hardware means, for example, the benchmark performance of the piece of hardware. The values shown in FIG. 2A indicate, for example, measurements of benchmark performance. Each vehicle 300 has a component for measuring the performance of the pieces of hardware, so that vehicle 300 measures the performance of the pieces of hardware and transmits the measurements to server device 100. The benchmark performance may be, for example, measured regularly during the use of the in-vehicle device. Each vehicle 300 may include storage for storing the measurements of the hardware performance. The storage is implemented by, for example, semiconductor memory.

For example, in the operation data on each application, a respective hardware performance is employed in a common manner. The values in FIG. 2A may be statistical values (statistical values of actual measurements) of benchmark performance measured during a predetermined time period, or may be actual measurements of benchmark performance measured at a certain timepoint. The statistical values may be, by way of example and not limited to, average values, mode values, median values, maximum values, or minimum values. The performance of a piece of hardware may be the catalog value of the piece of hardware. The performance information illustrated in FIG. 2A is an example of second performance information.

As illustrated in FIG. 2B, each operation log includes load information indicating processing loads resulting from the operation of an application (here, the application that vehicle 200 has requested to distribute). In the example in FIG. 2B, the load information includes CPU consumption, GPU consumption, and frames per second (fps). The operation log may also include processing loads on other pieces of hardware, such as a RAM and an IO, related to the operation of the application. It is to be noted that the operation log may include the operation log of at least one of the pieces of hardware related to the operation of the application.

The values shown in FIG. 2B indicate, for example, measurements of processing loads on the pieces of hardware. Each vehicle 300 has a component for measuring the processing loads on the pieces of hardware, so that, after the application is downloaded, vehicle 300 measures the processing loads on the pieces of hardware and transmits the measurements to server device 100. The processing loads may be measured regularly after the application is downloaded. Each vehicle 300 may include storage for storing the measurements of the processing loads. The storage is implemented by, for example, semiconductor memory.

For example, the operation data on an application includes processing loads specific to that application. The values in FIG. 2B may be statistical values (statistical values of actual measurements) of processing loads measured during a predetermined time period, or may be actual measurements of processing loads measured at a certain timepoint. The statistical values may be, by way of example and not limited to, average values, mode values, median values, maximum values, or minimum values.

If multiple applications are operating in vehicle 300, the operation data for each of the applications is generated and transmitted to server device 100.

As illustrated in FIG. 3, the hardware performance information includes information indicating the performance of each piece of hardware (processing unit) in vehicle 200. In the example in FIG. 3, this information includes the performance of a CPU, a GPU, and an IO (CPU performance, GPU performance, and IO performance). The hardware performance information may also include the performance of other pieces of hardware, such as a RAM, related to the operation of applications. It is to be noted that the hardware performance information may include the performance of at least one of the pieces of hardware related to the operation of applications.

The performance of a piece of hardware means, for example, the benchmark performance of the piece of hardware. The values shown in FIG. 3 indicate, for example, measurements of benchmark performance. Vehicle 200 has a component for measuring the performance of the pieces of hardware, so that vehicle 200 measures the performance of the pieces of hardware and transmits the measurements to server device 100. The benchmark performance may be, for example, measured regularly during the use of the in-vehicle device. Vehicle 200 may include storage for storing the measurements of the hardware performance. The storage may be implemented by, for example, semiconductor memory.

The values in FIG. 3 may be statistical values (statistical values of actual measurements) of benchmark performance measured during a predetermined time period, or may be actual measurements of benchmark performance measured at a certain timepoint. The statistical values may be, by way of example and not limited to, average values, mode values, median values, maximum values, or minimum values. The performance of a piece of hardware may be the catalog value of the piece of hardware.

The hardware performance information on vehicle 200 may be transmitted to server device 100 in the distribution request or at a time different from the time when the distribution request is transmitted. The performance information shown in FIG. 3 is an example of first performance information.

The information illustrated in FIGS. 2A to 3 is stored in, for example, storage 40.

Referring again to FIG. 1, received-content determiner 20 determines the content of data received by data receiver 10. Specifically, received-content determiner 20 determines whether the data received by data receiver 10 is operation data or a distribution request to distribute an application. For example, if the data includes an identifier indicating whether the data is a distribution request or operation data, received-content determiner 20 performs the determination based on the identifier.

Model builder 30 generates an operability prediction model (a model) or updates the model, based on the received operation data. The operability prediction model is a model for prediction of loads (processing loads) on the pieces of hardware (the in-vehicle device) in vehicle 200 under the assumption that the application is operated in vehicle 200; the prediction being based on the performance information on the in-vehicle device in vehicle 200 that has requested the distribution of the application, i.e., vehicle 200 to which the application has not been downloaded. Generating a new model and updating the model are examples of building a model. Model builder 30 is an example of a builder.

For example, based on the received operation data, model builder 30 applies the least squares method to generate, as the operability prediction model, equations indicating the relationship between the hardware performance and the processing loads. The least squares method may be, for example, the recursive least squares method. The equations are an example of a mathematical model.

Model builder 30 builds a mathematical model based on the performance information and the operation log of each of the one or more vehicles 300. The following illustrates a mathematical model that predicts the CPU consumption and the GPU consumption:

$$a 1 \times C P U performance + a 2 \times G P U performance + … + an \times I O performance = prediction value of C P U consumption , and \qquad ( Expression 1 )$$

$$b 1 \times C P U performance + b 2 \times G P U performance + … + bn \times I O performance = prediction value of G P U consumption , \qquad ( Expression 2 )$$

where a1, a2, . . . , an, and b1, b2, . . . , bn are coefficients. Model builder 30 calculates the coefficients using the least squares method based on the operation data (the second performance information and the operation log).

Given the operation data illustrated in FIGS. 2A and 2B, Expressions 1 and 2 are formulated based on the operation data on W vehicles 300 (W is an integer greater than or equal to three).

For multiple applications, model builder 30 builds models corresponding to the respective applications. Model builder 30 builds the model for each application based on the operation log for the application and on the performance information on vehicles 300. If new operation data is received from one or more vehicles 300, model builder 30 updates the generated model based on the received operation data. For example, based on the received new operation data, model builder 30 updates the coefficients indicated in Expressions 1 and 2. The multiple applications may include, for example, applications different in function, applications from different vendors, or applications in different versions.

Storage 40 stores (accumulates) the data received from data receiver 10, and the model built by model builder 30. For multiple applications, storage 40 stores multiple models corresponding to the respective applications. Storage 40 stores the applications and their corresponding models such that they are associated with each other.

Operability determiner 50 determines whether the application for which the distribution request has been received is operable in vehicle 200. The determination is based on: the model corresponding to the application and built based on the operation data on one or more vehicles 300 to which the application has been distributed; and the performance information on vehicle 200. If the application is determined to be operable, operability determiner 50 determines to distribute the application to vehicle 200. If the application is determined to be not operable, operability determiner 50 determines not to distribute the application to vehicle 200. It could also be said that operability determiner 50 determines, based on the model and the performance information on vehicle 200, whether to distribute the application to vehicle 200.

Determining whether the application is operable includes, for example, determining whether the performance (e.g., the specs) of the in-vehicle device is sufficient for the operation of the application. For example, whether the application is operable is determined so as to determine whether the application operates smoothly, e.g., whether the application operates without jerkiness.

Operability determiner 50 determines, based on data included in the distribution request from vehicle 200, whether the application is operable in the in-vehicle device to which the application is to be distributed. Using the model generated by model builder 30, operability determiner 50 determines the operability of the application based on the prediction values outputted by the model.

If storage 40 stores multiple models, operability determiner 50 selects one of the models corresponding to the application for which the distribution request has been received, and determines the operability of the application based on the selected model. Operability determiner 50 is an example of a determiner.

Data transmitter 60 transmits, to the in-vehicle device in vehicle 200 to which the application is to be distributed, items such as the operability determination result and the requested application. Data transmitter 60 distributes the application to vehicle 200 if operability determiner 50 determines to distribute the application. Data transmitter 60 includes, for example, a wireless communication circuit (a wireless communication module). Data transmitter 60 is an example of a transmitter.

### [2. Operations of Data Transmission System]

Now, with reference to FIGS. 4 to 9, operations of data transmission system 1 configured as above will be described. FIG. 4 is a flowchart illustrating operations (a data transmission method) of data transmission system 1 according to this embodiment. FIG. 4 illustrates operations performed by server device 100.

As illustrated in FIG. 4, received-content determiner 20 determines whether data is received (S11). Received-content determiner 20 determines whether data is received from vehicle 200 or 300.

If received-content determiner 20 determines that data is received (YES at S11), received-content determiner 20 obtains, from the received data, information for determining the type of the data (S12) and determines whether the received data is a distribution request (S13). If received-content determiner 20 determines that no data is received (NO at S11), received-content determiner 20 returns to step S11 to continue the process.

If received-content determiner 20 determines that the received data is not a distribution request (NO at S13), the received data is operation data. Model builder 30 then determines which application the operation data corresponds to, and determines whether any existing model corresponds to the identified application (S14).

It is to be noted that the operation data may be obtained at any time. For example, the operation data may be obtained regularly.

If model builder 30 determines that an existing model corresponds to the identified application (YES at S14), model builder 30 updates the existing model based on the received data (S15). If model builder 30 determines that no existing model corresponds to the identified application (NO at S14), model builder 30 generates a new model corresponding to the application (S16). The updated model or the generated new model is stored in storage 40.

If received-content determiner 20 determines that the received data is a distribution request (YES at S13), operability determiner 50 obtains the model corresponding to the requested application (S17). Operability determiner 50 obtains the model corresponding to the requested application by selecting (extracting) the model from the models stored in storage 40.

Using the model obtained at step S17, operability determiner 50 determines whether the application is operable in vehicle 200 that has transmitted the distribution request (S18).

Operability determiner 50 performs the determination at step S18 based on the model and the hardware performance information on vehicle 200. For example, operability determiner 50 predicts processing loads on the in-vehicle device under the assumption that the application is operated in vehicle 200; the prediction may be made by substituting the values included in the hardware performance information on vehicle 200 into the mathematical model including Expressions 1 and 2.

For example, assume that the information illustrated in FIG. 3 is obtained as the hardware performance information on vehicle 200. Operability determiner 50 calculates the prediction values of the CPU consumption and the GPU consumption by substituting 170, 250, and 40 mb/s for CPU performance, GPU performance, and IO performance indicated in Expressions 1 and 2, respectively. The prediction values indicate predicted loads on the in-vehicle device in vehicle 200 under the assumption that the application is operated in vehicle 200.

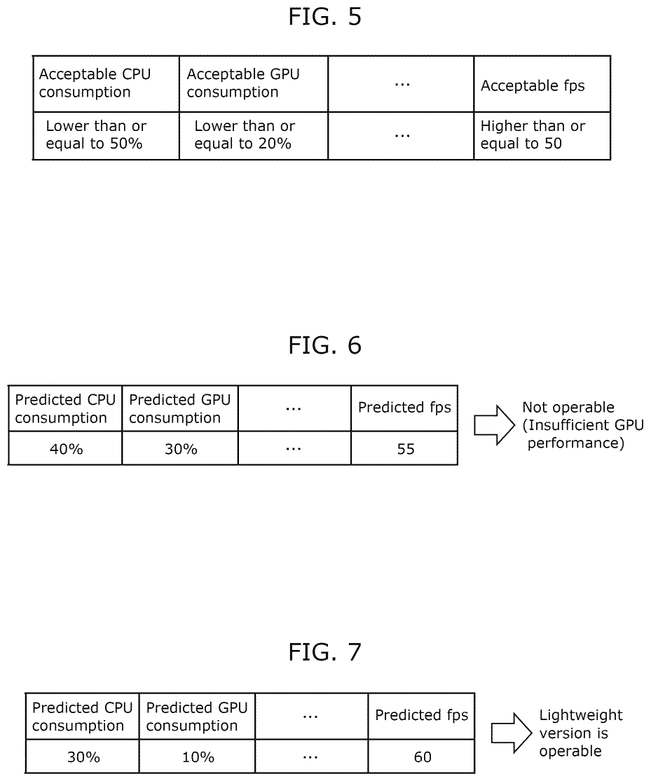

Operability determiner 50 determines the operability by comparing the prediction values predicted using the model with acceptable loads (thresholds or threshold ranges) stored in advance. FIG. 5 is a diagram illustrating an example of acceptable load information for vehicle 200 that has requested to distribute the application, according to this embodiment.

As illustrated in FIG. 5, the acceptable load information includes the following items: acceptable CPU consumption that indicates the acceptable limit to the CPU consumption, acceptable GPU consumption that indicates the acceptable limit to the GPU consumption, and acceptable fps that indicates the acceptable limit to fps. The acceptable load information includes the values of acceptable loads (the acceptable limits) for the respective prediction values calculated using the mathematical model. The acceptable load information is stored in advance in storage 40. The acceptable load information is set for individual vehicle 200 (e.g., for each vehicle model), and storage 40 stores the sets of acceptable load information and their corresponding pieces of vehicle identification information such that they are associated with each other.

If the prediction values predicted using the model satisfy all the items in the acceptable load information illustrated in FIG. 5, operability determiner 50 determines that the application is operable. If the prediction values fail to satisfy any one of the items in the acceptable load information illustrated in FIG. 5, operability determiner 50 determines that the application is not operable.

FIG. 6 is a diagram illustrating an example of the result of predicting the loads under the assumption that the application is operated in vehicle 200 that has requested to distribute the application, and the operability determination result, according to this embodiment. In the example illustrated in FIG. 6, for vehicle 200, the model predicts a predicted CPU consumption of 40% as the prediction value of the CPU consumption; a predicted GPU consumption of 30% as the prediction value of the GPU consumption; and a predicted fps of 55 as the prediction value of fps.

In this case, the predicted CPU consumption and the predicted fps satisfy the acceptable CPU consumption and the acceptable fps illustrated in FIG. 5, whereas the predicted GPU consumption does not satisfy the acceptable GPU consumption. Operability determiner 50 therefore determines that the application is not operable in vehicle 200 due to the insufficient GPU performance.

If operability determiner 50 determines that the application is operable (YES at S18), the application is considered to operate smoothly in vehicle 200. Operability determiner 50 therefore distributes the requested application to vehicle 200 (S19). The application can now operate in vehicle 200.

If server device 100 receives operation data obtained while the application is operating in vehicle 200, the model corresponding to the application may be updated based on the received data. In this manner, the accuracy of the model corresponding to the application can be improved by updating the model using the operation data from the vehicle (vehicle 200 in this example) to which the application has been distributed.

If step S18 results in YES, operability determiner 50 may allow the user to choose whether to download the application. If the user chooses to download the application, operability determiner 50 may perform the processing at step S19.

If the application is updated after being distributed by data transmitter 60 to vehicle 200, operability determiner 50 may determine, based on a model corresponding to the updated application, whether to distribute the updated application to vehicle 200. Operability determiner 50 performs this determination using the model corresponding to the updated application, built based on operation data on the updated application.

If operability determiner 50 determines that the application is not operable (NO at S18), operability determiner 50 determines whether there is a lightweight version of the requested application (S20). The lightweight version is an application having functions similar to those of the requested application and still being capable of reducing the loads on the in-vehicle device. The lightweight version may be, for example, an application with limited functions compared with the requested application. Whether there is a lightweight version of the application may be determined based on whether a lightweight version of the application is stored in storage 40, or whether a lightweight version of the application is operable, as illustrated in FIG. 7.

FIG. 7 is a diagram illustrating an example of the result of predicting the loads under the assumption that the lightweight version of the application is operated in vehicle 200 that has requested to distribute the application, and the operability determination result, according to this embodiment.

Operability determiner 50 predicts the loads under the assumption that the lightweight version of the application is operated in vehicle 200; the prediction is made by obtaining the model corresponding to the lightweight version of the application from storage 40 and inputting the hardware performance information illustrated in FIG. 3 to the obtained model. In the example illustrated in FIG. 7, a prediction is made for the CPU consumption as 30%, a prediction is made for the GPU consumption as 10%, and a prediction is made for fps as 60.

In this case, the acceptable limits for all the items illustrated in FIG. 5 are satisfied. Operability determiner 50 therefore determines that the lightweight version of the application is operable in vehicle 200, i.e., there is a lightweight version. If the acceptable limit for at least one item fails to be satisfied, operability determiner 50 determines that the lightweight version of the application is not operable, i.e., there is no lightweight version operable in vehicle 200.

If operability determiner 50 determines that there is a lightweight version (YES at S20), operability determiner 50 recommends the lightweight version to the user of vehicle 200 (S21). For example, if operability determiner 50 determines that the lightweight version of the application is operable in vehicle 200, operability determiner 50 may perform the processing at step S21.

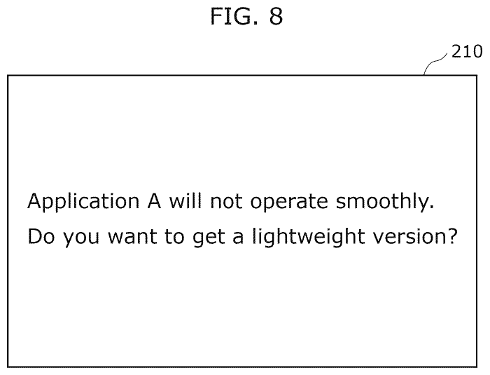

FIG. 8 is a diagram illustrating an example of a screen for recommending the lightweight version of the application, according to this embodiment. The diagram assumes that vehicle 200 has transmitted, to server device 100, a distribution request for application A.

As illustrated in FIG. 8, operability determiner 50 may cause terminal device 210 possessed by the user of vehicle 200 to display suggestion about the lightweight version of the application, such as “Application A will not operate smoothly. Do you want to get a lightweight version?” Operability determiner 50 may further cause the terminal device to display information that the lightweight version of the application will operate smoothly. The display illustrated in FIG. 8 is an example of the determination result.

Terminal device 210 may be a mobile terminal carried by the user, or an immovable device provided in vehicle 200. The mobile terminal is a device with a display function, for example a smartphone or a tablet. The immovable device is a device with a display function, for example a navigation device provided in vehicle 200. The display function may be implemented by a liquid crystal display, as a nonlimiting example.

If operability determiner 50 determines that there is no lightweight version (NO at S20), operability determiner 50 notifies vehicle 200 of the inability to distribute the application (S22). Operability determiner 50 can thus notify the user of vehicle 200 that the requested application is not distributed. The inability to distribute the application is an example of the determination result.

Operability determiner 50 may include, in the determination result, information indicating the reason for the determination of the inability to distribute the application. For example, in the example in FIG. 6, operability determiner 50 may include, in the determination result, information that the GPU performance is insufficient.

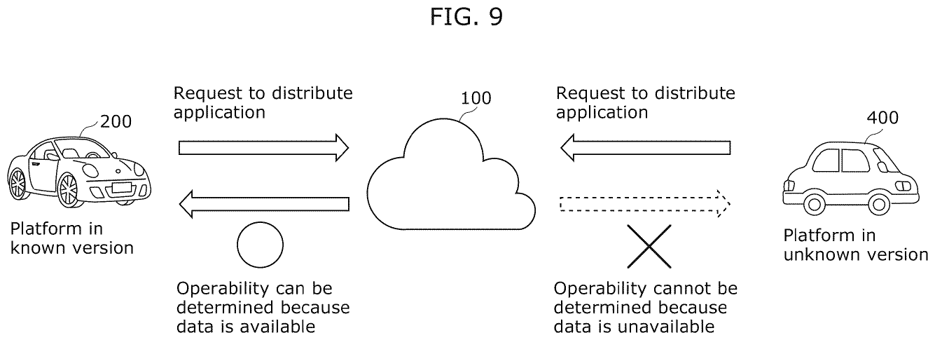

Operability determiner 50 may determine the operability of the application further based on the version of the platform of the in-vehicle device. FIG. 9 is a schematic diagram for describing the determination of the operability of the application based on the version of the platform of an in-vehicle device, according to this embodiment. In this case, storage 40 stores a large number of applications for multiple platform versions such that the applications are identifiable on a platform version basis.

As illustrated in FIG. 9, a distribution request for the application may be received from vehicle 200 having a platform in a known version. Operability determiner 50 determines that the operability of the application can be determined because operation data for that version can be obtained. The determination result may be transmitted to vehicle 200.

In contrast, a distribution request for the application may be received from vehicle 400 having a platform in an unknown version. Operability determiner 50 determines that the operability of the application cannot be determined because operation data for that version cannot be obtained. The determination result may be transmitted to vehicle 400.

Between steps S12 and S13 illustrated in FIG. 4, whether the version of the platform in vehicle 200 is a known version may be determined. If so, the processing at step S13 may be performed; otherwise, the process may be terminated.

Information indicating the version of the platform may be, for example, included in the distribution request and transmitted from vehicle 200 to server device 100.

### OTHER EMBODIMENTS

Although the data transmission system and the like according to one or more aspects of the present disclosure have been described based on the embodiment, the present disclosure is not limited to the embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

For example, although the above embodiment describes the example in which the model used is a mathematical model, this is not limiting. For example, the model may be a machine learning model. The machine learning model is configured, for example, to take input of the first performance information on an in-vehicle device in a vehicle that has requested to distribute an application, and to output information indicating the result of determining whether the application will operate smoothly in the in-vehicle device. The model builder generates, for example, a machine learning model through machine learning, in which the second performance information in the operation data is used as input information, and the operation log in the operation data is used as ground truth information. The machine learning model may be generated for each application, or alternatively, for example, the input information may include information indicating the application. The machine learning model is a neural network, although it may be a random forest or a decision tree, for example.

The above embodiment describes the example in which whether there is a lightweight version is determined if the requested application is not operable. However, this is not limiting. Whether there is a lightweight version may also be determined if the application is operable. Then, if there is a lightweight version, the user of the vehicle may be allowed to choose which to download: the requested application or the lightweight version of it. For example, if the predicted loads (see FIG. 6) just barely satisfy the acceptable loads (see FIG. 5), whether there is a lightweight version may be determined.

Each of the elements in each of the above embodiment may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

The order of steps in each flowchart is an example for explaining the present disclosure in more detail. The order of steps may be changed, or a part of the steps may be performed simultaneously with (in parallel to) another part of the steps. It is also possible to skip a part of the steps.

The dividing of the functional blocks in each of the block diagrams is one example. It is possible that a plurality of functional blocks are implemented into a single functional block, that a single functional block is divided into a plurality of functional blocks, and that a function executed by a functional block is partially executed by another functional block. Furthermore, similar functions of a plurality of functional blocks may be executed by a single hardware or software in parallel or by time division.

The server device according to the above-described embodiment may be implemented to a single device or include a plurality of devices. If the server device includes a plurality of devices, the way of allocating the constituent elements included in the server device to the plurality of devices is not limited. For example, at least a part of functions of the constituent elements include in server device may be included in a vehicle or a different server. If the server device includes a plurality of devices, a communication method between the plurality of devices is not limited. The communication method may be wireless communication or wired communication. It is also possible to combine wireless communication and wired communication between the plurality of devices.

Each constituent element described in the above embodiment may be implemented to software, or typically implemented into a Large Scale Integration (LSI) which is an integrated circuit. These may be integrated separately, or a part or all of them may be integrated into a single chip. Note that here, the terminology “system LSI circuit” is used, but depending on the degree of integration, the circuit may also referred to as IC, LSI circuit, super LSI circuit, or ultra LSI circuit. Moreover, the method of circuit integration is not limited to LSI. Integration may be realized with a specialized circuit or a general purpose processor. After the LSI circuit is manufactured, a field programmable gate array (FPGA) or a reconfigurable processor capable of reconfiguring the connections and settings of the circuit cells in the LSI circuit may be used. Further, if an integrated circuit technology that replaces LSI emerges from advances in or derivations of semiconductor technology, integration of functional blocks using such technology may also be used.

The system LSI is a super multi-function LSI that is a single. chip into which a plurality of constituent elements are integrated. More specifically, the system LSI is a computer system including a microprocessor, a Read Only Memory (ROM), a Random Access Memory (RAM), and the like. The ROM holds a computer program. The microprocessor operates according to the computer program, thereby causing the system LSI to execute its functions.

An aspect of the present disclosure may be a computer program for causing a computer to execute each characteristic step included in data transmission method which is presented in any of FIG. 4.

For example, the present disclosure may be implemented to a program that causes the computer to execute the above-described processing. Furthermore, an aspect of the present disclosure may be implemented to a non-transitory computer-readable recording medium storing such a program. For example, such a program may be recorded on a recording medium and distributed. For example, the distributed program may be installed in a device including a different processor, and cause the processor to execute the program, thereby causing the device to perform the above processing.

### SUPPLEMENTARY NOTE

(Technique 1) A data transmission system includes: a receiver (for example, data receiver 10) that receives, from a first vehicle, (i) a distribution request to distribute an application and (ii) first performance information indicating performance of an in-vehicle device provided to the first vehicle; a determiner (for example, operability determiner 50) that determines whether the application is operable in the first vehicle, based on the first performance information and a model corresponding to the application, the model being built based on operation data of each of one or more second vehicles to which the application has been distributed; and a transmitter (for example, data transmitter 60) that distributes the application to the first vehicle when the determiner determines that the application is operable in the first vehicle.

Thus, the application is distributed if the application is expected to operate smoothly in the in-vehicle device. In other words, the application is not distributed if the application is not expected to operate smoothly in the in-vehicle device. That is, whether to distribute the application is determined based on the performance of the in-vehicle device. In this manner, the data transmission system enables distributing an application that depends on the performance of the in-vehicle device.

(Technique 2) In the data transmission system according to technique 1, the model outputs, based on the first performance information, a prediction value of a load on the in-vehicle device under assumption that the application is operated in the first vehicle, and the determiner determines whether the application is operable in the first vehicle, based on the prediction value outputted by the model.

Thus, the determiner can use the prediction value of the load to determine whether the application is operable.

(Technique 3) The data transmission system according to technique 1 or technique 2 further includes: a builder (for example, model builder 30) that builds the model based on the operation data.

Thus, the model can be generated automatically.

(Technique 4) In the data transmission system according to technique 3, the builder builds the model using a least squares method based on the operation data of each of the one or more second vehicles.

Thus, the model can be built using the recursive least squares method.

(Technique 5) In the data transmission system according to technique 3 or technique 4, the operation data includes, for each of the one or more second vehicles, second performance information indicating performance of an in-vehicle device provided to the second vehicle, and an operation log regarding operation of the application in the in-vehicle device provided to the second vehicle, and the builder builds, as the model, a mathematical model based on the second performance information and the operation log of each of the one or more second vehicles.

Thus, whether the application is operable can be determined using the mathematical model.

(Technique 6) In the data transmission system according to technique any one of techniques 3 to 5, the receiver receives the operation data regularly from each of the one or more second vehicles, and the builder updates the model based on the operation data newly received from each of the one or more second vehicles.

Thus, updating the model can improve the prediction accuracy of the model.

(Technique 7) In the data transmission system according to any one of techniques 1 to 6, when the application is updated after the transmitter has distributed the application to the first vehicle, the determiner determines whether the application updated is operable in the first vehicle, based on a model corresponding to the application updated.

Thus, the updated application is distributed if the updated application is expected to operate smoothly in the in-vehicle device. In other words, the updated application is not distributed if the updated application is not expected to operate smoothly in the in-vehicle device. That is, whether to distribute the updated application is determined based on the performance of the in-vehicle device. In this manner, the data transmission system enables distributing an application (an updated application) that depends on the performance of the in-vehicle device.

(Technique 8) In the data transmission system according to any one of techniques 1 to 7, the application is one of a plurality of applications, the data transmission system further includes: a storage that stores a plurality of models each corresponding to a corresponding one of the plurality of applications, and the determiner selects, from the plurality of models, the model corresponding to the application for which the distribution request has been received by the receiver, and determines whether the application is operable in the first vehicle, based on the model selected.

Thus, the model corresponding to the application is selected to enable more accurate determination of the operability.

(Technique 9) In the data transmission system according to any one of techniques 1 to 8, when the determiner determines to distribute the application to the first vehicle, the determiner causes a user of the first vehicle to choose whether to download the application to the first vehicle, and when the user chooses to download the application to the first vehicle, the transmitter distributes the application to the first vehicle.

Thus, the user can be allowed to choose whether to download the application. That is, the user's intention can be reflected in the distribution of the application.

(Technique 10) In the data transmission system according to any one of techniques 1 to 9, when the determiner determines that the application is not operable in the first vehicle, the determiner further determines whether another application in which a function of the application is restricted is operable in the first vehicle, and when the determiner determines that the other application in which the function of the application is restricted is operable in the first vehicle, the transmitter distributes the other application to the first vehicle.

Thus, if the requested application is not operable, a lightweight version of the application can be distributed as an alternative.

(Technique 11) In the data transmission system according to technique 10, when the determiner determines that the other application in which the function of the application is restricted is operable in the first vehicle, the determiner causes a user of the first vehicle to choose whether to download the other application to the first vehicle, and when the user chooses to download the other application in which the function of the application is restricted to the first vehicle, the transmitter distributes the other application to the first vehicle.

Thus, the user can be allowed to choose whether to download the lightweight version of the application. That is, the user's intention can be reflected in the distribution of the lightweight version of the application.

(Technique 12) In the data transmission system according to any one of techniques 1 to 11, the first performance information includes at least one of a Central Processing Unit (CPU) performance, a Graphics Processing Unit (GPU) performance, or an Input/Output (IO) performance of the in-vehicle device provided to the first vehicle.

Thus, whether the application is operable can be determined based on at least one of the CPU performance, the GPU performance, or the IO performance in the first vehicle.

(Technique 13) In the data transmission system according to technique 5 or technique 6, the second performance information includes at least one of a Central Processing Unit (CPU) performance, a Graphics Processing Unit (GPU) performance, or an Input/Output (IO) performance of the in-vehicle device provided to a corresponding one of the one or more second vehicles, and the operation log includes at least one of a CPU consumption, a GPU consumption, or a frame rate of the in-vehicle device provided to the corresponding one of the one or more second vehicles.

Thus, whether the application is operable can be determined based on at least one of the CPU performance, the GPU performance, or the IO performance in the second vehicles, and at least one of the CPU consumption, the GPU consumption, or the frame rate in the second vehicles.

(Technique 14) A data transmission method includes: receiving, from a first vehicle, a distribution request for an application and first performance information indicating performance of an in-vehicle device provided to the first vehicle; determining whether the application is operable in the first vehicle, based on the first performance information and a model corresponding to the application, the model being built based on operation data of each of one or more second vehicles to which the application has been distributed; and distributing the application to the first vehicle when the determining is made that the application is operable in the first vehicle. Furthermore, (Technique 15) A recording medium is a non-transitory computer-readable recording medium for use in a computer, the recording medium having recorded thereon a computer program for causing the computer to execute the data transmission method according to technique 14.

With this, it is possible to produce the same advantageous effects as those of the above-described data transmission system.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-218660 filed on Dec. 25, 2023.

### INDUSTRIAL APPLICABILITY

The present disclosure is applicable to a data transmission system or the like that distributes a given application to in-vehicle devices.

1. A data transmission system comprising:
a receiver that receives, from a first vehicle, (i) a distribution request to distribute an application and (ii) first performance information indicating performance of an in-vehicle device provided to the first vehicle;
a determiner that determines whether the application is operable in the first vehicle, based on the first performance information and a model corresponding to the application, the model being built based on operation data of each of one or more second vehicles to which the application has been distributed; and
a transmitter that distributes the application to the first vehicle when the determiner determines that the application is operable in the first vehicle.

2. The data transmission system according to claim 1, wherein
the model outputs, based on the first performance information, a prediction value of a load on the in-vehicle device under assumption that the application is operated in the first vehicle, and
the determiner determines whether the application is operable in the first vehicle, based on the prediction value outputted by the model.

3. The data transmission system according to claim 1, further comprising:
a builder that builds the model based on the operation data.

4. The data transmission system according to claim 3, wherein
the builder builds the model using a least squares method based on the operation data of each of the one or more second vehicles.

5. The data transmission system according to claim 3, wherein
the operation data includes, for each of the one or more second vehicles, second performance information indicating performance of an in-vehicle device provided to the second vehicle, and an operation log regarding operation of the application in the in-vehicle device provided to the second vehicle, and
the builder builds, as the model, a mathematical model based on the second performance information and the operation log of each of the one or more second vehicles.

6. The data transmission system according to claim 3, wherein
the receiver receives the operation data regularly from each of the one or more second vehicles, and
the builder updates the model based on the operation data newly received from each of the one or more second vehicles.

7. The data transmission system according to claim 1, wherein
when the application is updated after the transmitter has distributed the application to the first vehicle, the determiner determines whether the application updated is operable in the first vehicle, based on a model corresponding to the application updated.

8. The data transmission system according to claim 1, wherein
the application is one of a plurality of applications,
the data transmission system further comprises:
a storage that stores a plurality of models each corresponding to a corresponding one of the plurality of applications, and
the determiner selects, from the plurality of models, the model corresponding to the application for which the distribution request has been received by the receiver, and determines whether the application is operable in the first vehicle, based on the model selected.

9. The data transmission system according to claim 1, wherein
when the determiner determines to distribute the application to the first vehicle, the determiner causes a user of the first vehicle to choose whether to download the application to the first vehicle, and
when the user chooses to download the application to the first vehicle, the transmitter distributes the application to the first vehicle.

10. The data transmission system according to claim 1, wherein
when the determiner determines that the application is not operable in the first vehicle, the determiner further determines whether an other application in which a function of the application is restricted is operable in the first vehicle, and
when the determiner determines that the other application in which the function of the application is restricted is operable in the first vehicle, the transmitter distributes the other application to the first vehicle.

11. The data transmission system according to claim 10, wherein
when the determiner determines that the other application in which the function of the application is restricted is operable in the first vehicle, the determiner causes a user of the first vehicle to choose whether to download the other application to the first vehicle, and
when the user chooses to download the other application in which the function of the application is restricted to the first vehicle, the transmitter distributes the other application to the first vehicle.

12. The data transmission system according to claim 1, wherein
the first performance information includes at least one of a Central Processing Unit (CPU) performance, a Graphics Processing Unit (GPU) performance, or an Input/Output (IO) performance of the in-vehicle device provided to the first vehicle.

13. The data transmission system according to claim 5, wherein
the second performance information includes at least one of a Central Processing Unit (CPU) performance, a Graphics Processing Unit (GPU) performance, or an Input/Output (IO) performance of the in-vehicle device provided to a corresponding one of the one or more second vehicles, and
the operation log includes at least one of a CPU consumption, a GPU consumption, or a frame rate of the in-vehicle device provided to the corresponding one of the one or more second vehicles.

14. A data transmission method comprising:
receiving, from a first vehicle, a distribution request for an application and first performance information indicating performance of an in-vehicle device provided to the first vehicle;
determining whether the application is operable in the first vehicle, based on the first performance information and a model corresponding to the application, the model being built based on operation data of each of one or more second vehicles to which the application has been distributed; and
distributing the application to the first vehicle when the determining is made that the application is operable in the first vehicle.

15. A non-transitory computer-readable recording medium for use in a computer, the recording medium having recorded thereon a computer program for causing the computer to execute the data transmission method according to claim 14.
